(19) United States
(12) Patent Application Publication
(10) Pub. No.: US 2007/0186007 A1
(43) Pub. Date: Aug. 9, 2007

(54) DOWNLOADABLE SERVER-CLIENT COLLABORATIVE MOBILE SOCIAL COMPUTING APPLICATION

(76) Inventors: Andrew S. FIELD, Pittsburgh, PA (US); Allen J. Geary, Pittsburgh, PA (US)

Correspondence Address: REED SMITH LLP, P.O. BOX 488, PITTSBURGH, PA, 15230-0488, US

(21) Appl. No.: 11/672,923

(22) Filed: Feb. 8, 2007

Related U.S. Application Data
(60) Provisional application No. 60/771,346, filed on Feb. 8, 2006.

(51) Int. Cl. G06F 15/16

(52) U.S. Cl. 709/233

(57) ABSTRACT

Systems and methods for collaborative and interactive computer applications. A downloadable server-client collaborative mobile social computing application and methods for using the same that connect users based on both their physical location and mutual geographic proximity. A wide variety of Web-enabled devices may be used by members to access the system and interact with other members using both geographic proximity and user-defined preferences to match different users. The system is characterized by its location based services and high degree of user configurable options to provide users with both an entertaining experience and rich social interactions.

### CROSS-REFERENCE TO RELATED APPLICATION

this application claims the benefit under 35 U.S.C. §119(e) of the earlier filing date of U.S. Provisional Application Ser. No. 60/771,346 filed on Feb. 8, 2006.

### BACKGROUND OF THE INVENTION

1. Field of the Invention

The present invention relates generally to collaborative or interactive computer applications, and, more specifically, the present invention is directed to downloadable server-client collaborative mobile social computing applications and methods that connect users based on both their physical location and mutual geographic proximity.

2. Description of the Background

In recent years, social computing generally and collaborative computer applications specifically have grown in both popularity and sophistication. Since the launch of the first social networking website in 1995, to date more than 300 social networking sites have appeared on the World Wide Web. The numbers of these sites has increased because, in their daily lives, people naturally and routinely operate within their social personal networks to meet new people. People seek these meetings for a variety of reasons, including romantic involvement, friendship, activity partners, and/or professional and commercial benefit. The vast majority of marriages, romantic relationships and friendships are developed through social networks. In business, it is not a secret that the difference between failure and success often depends not on “what you know,” but rather “who you know.”

There are several reasons a person may prefer to meet new people through social networks: it is more comfortable; it is more efficient; and it is more likely to lead to desirable relationships than other methods. A great benefit of interacting through a social network is the enhanced efficiency of the process and the higher quality of relationships established through social networks. When two individuals meet through a mutual acquaintance (or series of such acquaintances), they are more likely to be compatible for the simple reason that their mutual friendship is itself likely to be indicative of shared preferences and interests.

Several social networking sites exist on the Web which attempt to link people within a social network. A user of such a site may post a profile and invite their friends to do the same. Soon there is an entire network connecting like-minded people with the potential to spread endlessly around the world. Many current social networking websites offer both business and social networking. These social networking sites, however, do not provide for live interaction amongst users, or for the matching of users based on shared interests.

The Web also offers several matching sites which attempt to connect people who do not know each other, but who may have similar interests in anything from sports and music to business and politics. These matching sites allow users to post profiles and photos, as well as search through the profiles and photos of other users. Matching features are provided which connect users based on indicated profile criteria about themselves and their desired matches.

Communication between users on these types of websites generally involves a process akin to email. These sites lack the spontaneity of live social networking or “matchmaker” events, and the interaction between users lacks the atmosphere of live conversation. Furthermore, these sites provide no mechanism to encourage interaction between users, or to help break the ice. For these reasons, users of these websites may find it difficult to communicate with other users, or might find that a potential match who appeared desirable from their posted profile may not be as desirable as initially perceived.

In addition, each of these Web-based sites fails to address the need for people to network with one another in their current geographic location in real-time. Voice, video, and web collaboration is not designed to replace in-person interaction, but rather to complement it by creating an environment that is as close as possible to being present and enabling people to work and communicate effectively over distances. Thus, each of these websites fails to effectively harness the clear advantages of live “in-person” social networks.

The ability to compute anywhere, anytime is growing rapidly as both mobile Internet-enabled devices are increasing in popularity and the availability of public Internet access points is growing. Currently, there are tens of thousands of public and private open access hot spots, and the number of communities interested in building their own wireless networks is on the rise. Verizon Wireless Broadband Access, for example, is currently available to more than 140 million American laptop owners in 171 major metropolitan areas. Moreover, there are nearly 40,000 Wi-Fi networks in commercial locations in the United States, and ninety-eight percent of the top 50 college campuses are covered by a wireless network.

None of the previously mentioned Web-based sites takes full advantage of this explosion in mobile computing. In particular, none of these sites allows a user to participate in a collaborative online social experience with members based on their current, actual geographic location. Additionally, none of the advantages of live social networks, specifically the critical function performed by mutual acquaintances and the ability to interact in live conversation with people in one's own local area, exists in current networking systems.

The present invention, through its integrated use of location based services, live interaction of social networks and system-guided introductions between users, addresses these and other limitations of the prior art. Through these and other attributes, the present invention provides a truly collaborative mobile social computing platform that connects members based upon their physical location as well as mutual geographic proximity via the one or more preferred embodiments described herein.

### SUMMARY OF THE INVENTION

The present invention provides an extensible platform which employs Web-based device access to facilitate immediate personal connections between traditional Internet users, and between mobile computer users who are simultaneously located in commercial and non-commercial venues. Users are presented with an interactive graphical user interface that may (1) visually depict the presence and location of other users, (2) provide the ability to communicate with users based on real-time geographic proximity and (3) offer a large menu of collaborative entertainment, games and networked social activities,

The present invention is characterized by the combined use of user-provided information with the actual, real-world location of the user at the time of use. In this way, the system not only matches different users that have apparent common interests, but the system can also account for and make advantageous use of the geographic proximity and physical location of the users. This combination of location based services and extensive interactive content provide a rich and comprehensive experience for the user.

The system also provides a great deal of user configurability and flexibility to ensure that all users are comfortable with their experience with the system. The main user screen of the application provides simple drag-and-drop layout editing functionality, and a wide variety of user-definable options are accessed directly from the screen. Many varieties of games, personal Web pages and other interactive social activities are incorporated into the present system—many using the location based services that provide an additional level of user matching. Additionally, an invitation system that allows users to quiz each other prior to interacting may be employed to provide yet another confirmation that two users are compatible in advance of their system-facilitated social interaction.

The presently preferred embodiments of the invention have many features, no single one of which is solely responsible for its desirable attributes. Without limiting the scope of this invention as expressed by the claims, its more prominent features are described in the “DETAILED DESCRIPTION OF THE INVENTION.” One skilled in the appropriate art will readily understand how the features of this invention provide several advantages over traditional “social networking” or “matching” systems and how the teachings of the present application can be extended to other similar features and advantages as are well known in the art.

### BRIEF DESCRIPTION OF THE DRAWINGS

For the present invention to be clearly understood and readily practiced, the various preferred embodiments will be described in conjunction with the following figures, wherein like reference characters designate the same or similar elements, which figures are incorporated into and constitute a part of the specification, wherein:

FIG. 1 is an exemplary system schematic diagram;

FIG. 2 is a flowchart illustrating an exemplary use of location based services;

FIG. 3 is a schemata for organization of location information within a database;

FIG. 4 is a schemata for organization of user information within a database;

FIG. 5 is a schemata for organization of component information within a database;

FIG. 6 is an exemplary graphical user interface for displaying the main screen of the present invention to an end user;

FIG. 7 is an exemplary graphical user interface for displaying a Q-factor Quiz screen;

FIG. 8 is an exemplary graphical user interface for displaying a user blog (web log) screen;

FIG. 9 is an exemplary graphical user interface for entry of a user's account information;

FIG. 10 is a flowchart illustrating a user's interaction with the system upon login to the system;

FIG. 11 is an exemplary graphical user interface which displays location selection for a user logging onto the system including location confirmation (FIG. 11A) and location selection (FIG. 11B) screens;

FIG. 12 is a flowchart illustrating a user's toolbar options from the main screen;

FIG. 13 is a flowchart illustrating a user's Q-button options from the main screen;

FIG. 14 is a screen shot from an exemplary social game of the present invention;

FIG. 15 is a flowchart illustrating a user's interaction options from the main screen;

FIG. 16 is a flowchart illustrating an exemplary invitation workflow process;

FIG. 17 is an exemplary graphical user interface with which a user may edit a question asked upon an invitation from another user;

FIG. 18 is an exemplary graphical user interface which displays a “My Q-Factor Quiz” to a user who is requesting an interaction;

FIG. 19 is an exemplary graphical user interface which displays a response to a “My Q-Factor Quiz” in an interaction;

FIG. 20 is an exemplary graphical user interface for displaying an invitation screen; and

FIG. 21 is a screen shot of an exemplary user game.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided herein below with reference to the attached drawings.

In comparison to the existing first generation social computing applications, the present invention provides users with a participatory social experience rather than a solitary one. In its preferred embodiments, the invention provides a unique online gathering place with the ambiance of a lively party, a neighborhood pub or coffeehouse. The system encourages users to participate as part audience member and part actor. In short, the present invention offers a bridge between the virtual realm of the Internet and a user's shared real-world surroundings.

In its preferred embodiments, the application incorporates five fundamental design attributes: (1) a user's experience on the application occurs in real-time; (2) the application provides location-aware features which allow a user to define a location-based social network; (3) the application provides collaborative activities such as games and quizzes that involve any number of users; (4) the application acts as a party host by introducing users and by initiating games and/or conversations amongst users; and (5) the application constantly searches for users with similar interests and for opportunities of personal interest for a user.

The present invention, in at least one preferred embodiment, provides a client-server application. The client may be any device that may be connected to the Internet, including at least personal computers (PCs), mobile computers, tablet computers, mobile phones, smart phones, and Personal Digital Assistants (PDAs). The server is preferably a multi-interface environment comprising an HTTP or direct connection to a Java Runtime Environment. The application may be compatible with all current operating environments capable of connecting to the Internet.

The material below begins with a high level description of the collaborative mobile social computing application/platform according to the present invention including a description of the system's unique use of users' physical locations and mutual geographic proximity. Thereafter, a detailed description of a wide variety of different program modules (games, chat, etc.) for use with the system is provided. Finally, certain low level examples of uses of the system are provided in order to more clearly set forth the scope of the present invention.

### High Level Description

### A. The Mobile Social Computing System

The present invention provides an extensible platform which employs both Internet and wireless access to facilitate immediate personal connections between traditional Internet users, and between mobile computer users who are simultaneously located in commercial and non-commercial venues. Users of the system are presented with an interactive graphical user interface (GUI) that may: (1) visually depict the presence and location of other users; (2) provide the ability to communicate with users based on real-time geographic proximity; and (3) offer a large menu of collaborative entertainment, games and networked social activities.

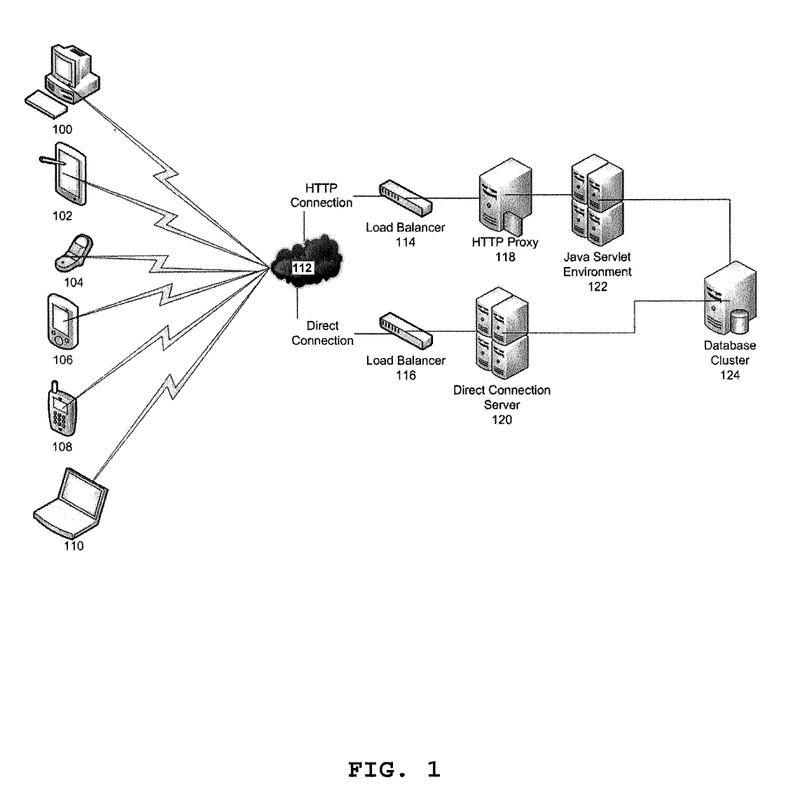

FIG. 1 shows a high level system diagram according to an embodiment of the present invention. A user may access the system from any of a wide array of devices (100-110) that may be connected to the Internet 112. For example, user devices may include, but are not limited to, personal computers 100, tablet computers 102, cellular telephones 104, PDAs 106, smart phones 108, and mobile laptop computers 110.

The system preferably allows users (i.e., clients) to connect to the application servers in one of two ways. First, a user may attempt to open a persistent socket directly to the application servers. Once this connection is opened, it remains open and all further communications occur synchronously across this connection. The persistent socket allows for push/pull communications and the richest user experience. As shown in the lower portion of FIG. 1, such a connection may be passed through a load balancer 116 prior to connection with a direct connection server 120 to maintain even traffic across a plurality of application servers.

However, if the user device cannot open a direct connection due to firewall restrictions or poor network conditions, the client connection manager fails and opens a stateless HTTP connection. The HTTP connection is a polling connection that constantly opens and closes connections, polling the servers for queued data. As shown in the upper portion of FIG. 1, such a connection may be passed through a load balancer 114 to the HTTP proxy 118 before reaching the Java Servlet environment 122. The system may switch seamlessly between these two modes while running, transparent to the user, for the best user experience.

When accessed by either method, as shown in FIG. 1, the back-end data resides in a database cluster 124. When accessed through the direct connection, a load balancer 116 and direct connection server 120 are used to facilitate communications between the user device and the database cluster 124. Similarly, when an HTTP connection is used, a load balancer 114, HTTP proxy server 118 and Java Servlet environment server 122 are used to facilitate access to and interaction with the database cluster 124.

The application client, which is a small downloadable application run from the client's device, is designed using both Java Swing and Java 2D to provide users with a graphics-rich environment. Most graphics and sounds are locally cached so that they may be readily re-used and re-processed, increasing creative options and client response time. The application client uses an enhanced media framework, permitting content developers to create activity content more efficiently. The application client has been designed to provide maximum user control of the application experience.

A serialization engine may be provided for users who do not wish to have any software downloaded onto their device. The serialization engine allows disparate devices, operating systems and development languages to connect to the application servers. Any networked device which can read and write XML can connect to the application servers and interact with other users running any other networked device. As an example, Macromedia Flash elements on a personal computer may communicate with PDAs or cell phones viewing an HTML page or with users running the application client.

Serialization is the process of saving an object onto a storage medium or transmitting it across a network connection link. This format can be used to re-create an object that is identical in its internal state to the original object. Extensions and modifications of the serialization methods provided by the Java Development Kit provide better performance and interoperability. The application serialization manager of the present invention allows various serialization methods, along with compression and encryption, to be integrated allowing seamless communication between various network devices.

An additional method of communication with the application allows a user to deploy individual components of the application outside of the application framework. In other words, a user may deploy a window which shows the number of users currently using the application on his/her personal webpage or third party website. The application activity and widget framework (discussed below) allows for deployment outside of the application client by packaging these elements as Java Applets. These Applets may then connect directly with the server environment, allowing users to experience the application environment without using the application client (i.e., the downloadable application run from the user's device). Applets can be placed on any website, in or out of the application environment.

Various aspects of the application client preferably utilize incremental downloads to decrease the initial download size and clutter on a user's network device. In practice, only elements required to run the application are loaded to a network device. This download strategy is most easily recognized by the following four components of the system.

First, the system “Launcher” application is a small application used to execute the application client. The Launcher first determines the correct server with which to connect. Once a server has been selected, the Launcher compares its file set with what is required to run the client in order to ensure that all necessary files are stored locally on the user's network device. The Launcher allows for system versioning and device management, storing only those elements which are needed to run the client (user device).

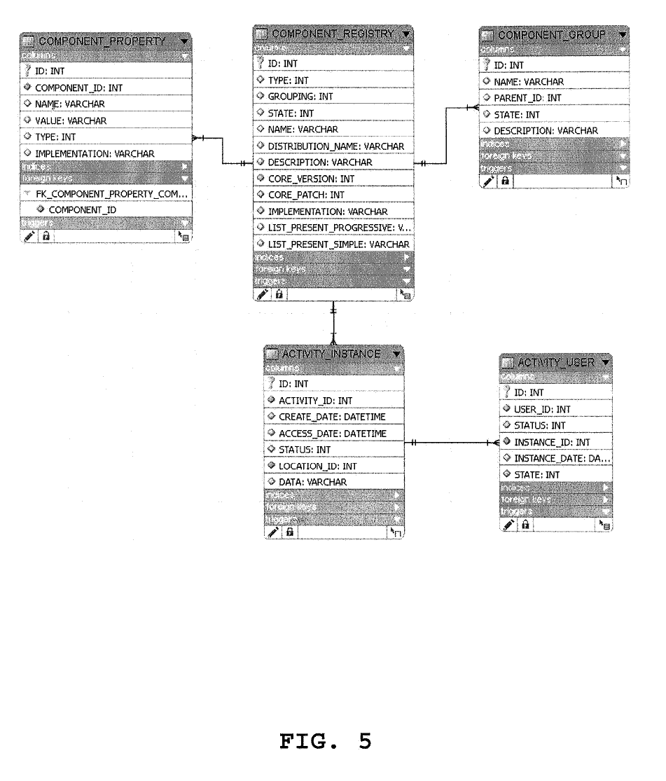

Second, all widgets and activities in the system are referred to as components. A widget, as used herein, refers to an interactive, user configurable filter that conveys dynamic information about users within a defined radius or “LANscape.” The Component Registry (see FIG. 5) contains a map of all components or widgets and their current version. Once a user chooses to run an activity or view a widget, the Component Registry gets the correct version of the component, downloads it to the network device, and seamlessly executes it in the current client instance using a custom Java class loader. All of the verification and downloading happens without the user's knowledge.

Third, most aspects of the application involve configurability. The Content Registry controls all modifiable content throughout the system. Content may be defined as any modifiable piece of data used by the application, its activities or widgets. Application content is made up of application supplied data and user generated data, allowing for the application experience to be uniquely branded to each user.

Finally, along with components and content, various multimedia elements such as graphics, sounds and videos, are downloaded on demand as well. Using the application cache engine, the elements are only downloaded when needed and only stored on the network device if required. Through the use of these four and other techniques, the system of the present invention provides incremental downloads to user devices in order to get users up and running quickly, and to decrease clutter on their devices.

### B. Location-Based Services

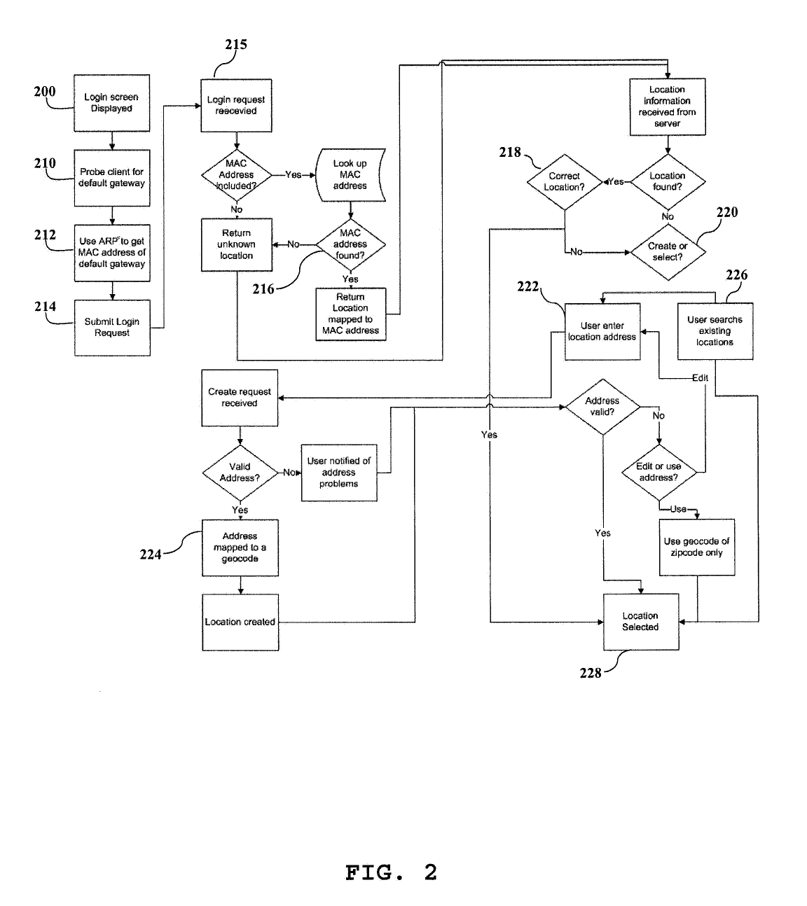

One important aspect of the present invention is the use of location based services (LBS) to define a social network or LANscape. Many of the application's most powerful features utilize LBS. With reference to FIG. 2, when a user logs into the system, LBS automatically pinpoints their physical location by obtaining the hardware (MAC) address of their Internet connection device (or wireless access point) and comparing it with a proprietary MAC address database containing location names and street addresses, longitude and latitude data, location type, and similar location data. When these and other LBS techniques have identified the location of the user (and the user has confirmed that location), the application then “maps” the user into their personal social network or “LANscape” consisting of all the other members who are online and within a default (or user-defined) geographic radius from the user's login location.

If the system is unable to match the user's hardware address in the LBS database, then the system will prompt the user to enter their login address. LBS will then utilize address resolution to ascertain the user's physical location using geo-coding. Along with the LBS system, the location verification algorithms are responsible for constantly verifying that a particular user location has the appropriate radius assigned to it. The radius is used to select a group of users by distance. If an acceptable number of users can be found at, for example, 0.5 miles or 50 miles, the appropriate radius is set.

As generally described above, when a member logs into the application, the system attempts to pinpoint the location of the user's device. There are generally two ways in which this is accomplished. First, the user device's MAC address may be used. Second, if this fails, the user may be queried to provide location information. Each of these techniques is described below with reference to FIG. 2.

The primary location technique uses the MAC address of the first route point from the client device to the Internet. For coffee shops and public locations, this will most likely be a wireless router or access point. For schools and private locations, this will be the hub, switch or router through which the users connect to the Internet. For home users, this could be a cable modem, DSL router or any other network device used to connect to the Internet.

After displaying the login screen (200) the application will use various commands on the users system to first find the IP address of the user's default gateway (210). This address represents the IP address of the first route point which is the network device to which an application location will be mapped. Various operating systems provide the information in different ways. Currently, on Microsoft Windows system the command “ipconfig” is used where as UNIX based system use “ifconfig.”

Once this address is obtained, the system uses the system ARP (Address Resolution Protocol) cache to obtain the MAC address of the network device (212). ARP is used to map MAC addresses to IP addresses. By using the “arp” command, the system can obtain the local mappings used to map the IP address of the default gateway to the MAC address. Once the MAC address is obtained (if available), the system passes the information to the application server environment (214-215). If found, the application compares this record with existing location records stored in the system to find a location match (216). If the application finds a location, the location information is passed back to the client machine for user verification (218). There the user can verify (218) that the matched location is the location at which the user is currently situated.

If the location is not found in the system database or the user could not verify the location, the application prompts the user to create (220) a new location by entering the location name and “type” along with a street address (222). The system then uses geo-coding (224) to map the entered location street address to a longitude/latitude point and stores that information in the system database. Once the location is subsequently verified by the system, all other users will be able to login from and view this location.

A second main way in which user location information is obtained is through direct user input (220). For example, if the location could not be mapped to a longitude/latitude point, the application allows users to select a location from a list of known locations (226). The system uses IP mapping to get a rough estimate of a user's location, and then it shows the user a pre-filtered view of locations in proximity to the user. The system allows the user to select one of these pre-filtered locations, or modify the filter criteria to choose from any of the pre-defined locations. In any of the above cases, the location of the user is ultimately confirmed by the system (228).

### C. The Server Databases

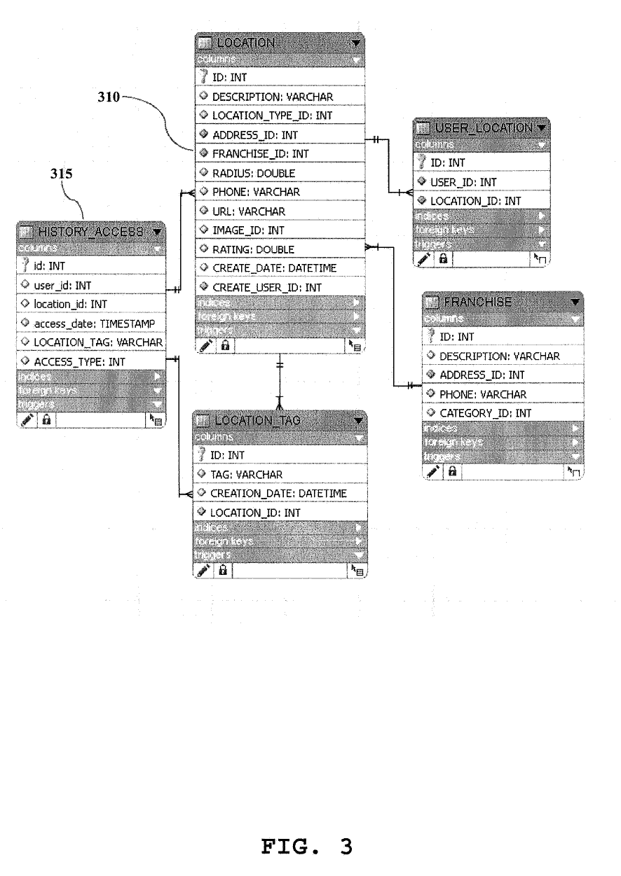

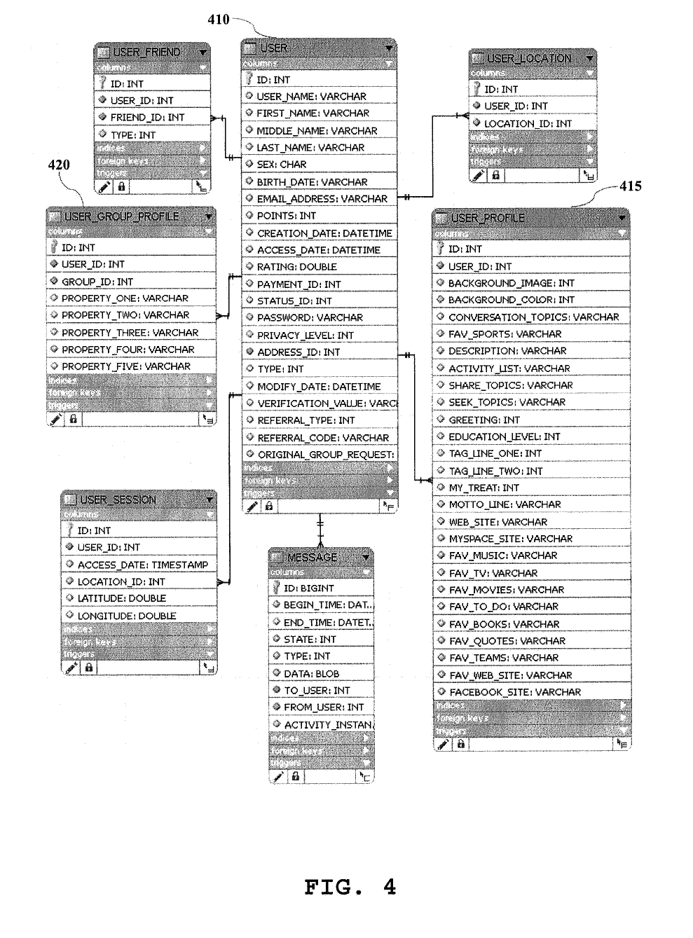

At the core of the present invention, the system employs a variety of databases which store various administrative and content information and that allow for a wide array of location-based interactions between users of the system. FIGS. 3, 4 and 5 show the general structure of three of the main databases for use as part of the present invention. Generally, FIG. 3 refers to location-specific databases, FIG. 4 refers to user-specific databases, and FIG. 5 refers to component-based databases. A high level discussion of these databases is provided below.

The “Location” database schema (FIG. 3) contains information pertaining to physical locations that users may inhabit. A location may be either private or public. In embodiments of the location database, the location may be further divided into personal, college, commercial and unknown. For example, a database record for a commercial location, or franchise (310), may allow advertising and branding of the user experience to be customized by location and by franchise. History Access (315) contains a mapping of demographic information describing the types of users logging into the types of locations and a tracking of the time frame for such logins.

The “User Information” schema (FIG. 4) contains profile and grouping information pertaining to a user. A user (410) can have stated profile information along with customizable profile information (415). Along with this, users have groups (420) which help categorize users. Users can be grouped by any means including college, profession and others.

The “Component” information schema (FIG. 5) stores all information pertaining to system activities and widgets. All activity and widgets in the system are recorded here along with individual running instances.

In more detail, the system component registry (shown in FIG. 5) is the core component of incremental downloads and allows the application to create or improve components such as activities and widgets. Once a component is registered within the system it will immediately be available for all clients currently logged into the application as well as all future logins. Once a component is started, the registry will determine if the client currently has the component locally and if it is the correct version of the component. If not, the registry will request the versioned component from the component service. Once the server returns the component, the component “ClassLoader” will load the component, and it will be ready for use without the client needing to restart his/her device. Also, the component will be available for all future client sessions.

Preferably, all aspects of the client device/application are fully configurable. This configurability may take a wide variety of forms. For example, as described below, specific programming techniques are utilized to provide extensive user interface customization, a compatibility engine is used to constantly assess and update user compatibility, and adaptive LBS and configurable cache attributes are used to provide a unique and pleasing experience for each user.

The application of the present invention is preferably designed using the model-view-controller (“MVC”) pattern. MVC is a design pattern used in software engineering. In complex computer applications that present lots of data to the user, it is best to separate data (model) and user interface (view) concerns, so that changes to the user interface do not impact the data handling, and so that the data can be reorganized without changing the user interface. The model-view-controller design pattern addresses this problem by decoupling data access and business logic from data presentation and user interaction through the introduction of an intermediate component: the controller. Using XML, the system allows the view and controller implementation to be modified. Modifying the view portion allows a level of “skinning” to occur, where the entire user interface is replaced with another. This can be accomplished by the application developers and end users alike, allowing for more unique and personalized application environments.

Another aspect of configurability is compatibility. The system's compatibility is determined by comparing various data objects. A data object is a collection of name/value pairs and can be a user profile, a location or any other piece of abstract data. The system employs a data object compatibility engine (DOCE) to compare various data objects. The DOCE is a scriptable compatibility engine allowing users, locations or other objects to be compared for compatibility.

The data comparisons are scriptable, allowing the developers to devise numerous ways to rate the compatibility between users or locations. By doing this, users may be more closely matched with each other. Further, application developers and users alike may create and modify comparison techniques, further personalizing the application experience.

Additionally, the application caching subsystem allows a user to configure how and where data is cached. This technique allows users to control storage system usage versus network bandwidth. By default, the application creates a smart caching scheme for the user's network device.

Finally, the present invention may also provide configurability through location quality of service. Specifically, the system monitors all locations to allow new logins to be provided with the best set of users with which to interact. The application server employs multiple subsystems to monitor the data quality. One such subsystem is the Intelligent User Population system (IUP). The IUP constantly monitors all possible user locations throughout the network in order to determine the optimal default social network or LANscape radius for each location. The objective is to insure that users always find an ideal number of other members in their LANscape social network with which to interact. This “ideal” member number may be defined by the system or may be defined by the user and the “radius” of users is automatically adjusted to match with the “ideal” user member number.

### The Software Modules in Detail

As described above, the present mobile social computing system can incorporate a wide variety of software applications or modules on the mobile device that may be employed by the user/member to interact with other members. Many of these modules incorporate the use of physical location and/or geographic proximity of the members in order to provide a truly collaborative mobile social computing platform that connects members based upon their physical location as well as mutual geographic proximity. The invention generally includes the key infrastructure components set forth below.

### A. The Main Screen

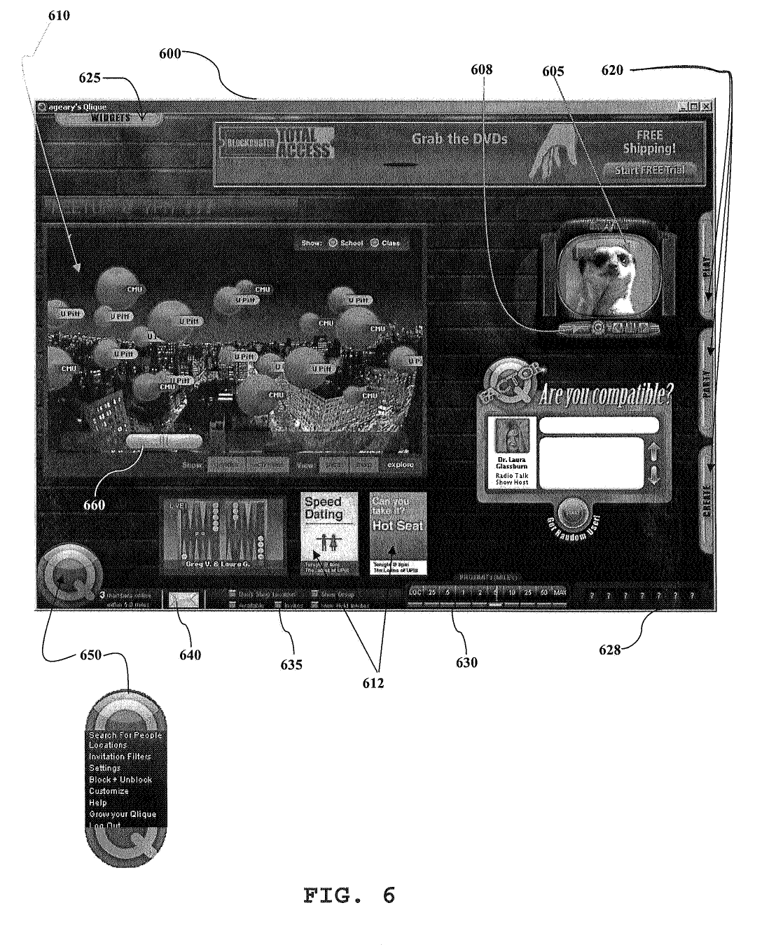

The user interface of the client devices consists of a series of web pages and applets that are used to provide various content, games and interactive experiences to the user. The starting point and central portal to the system is the “main” screen from which a variety of functions can be accessed. FIG. 6 shows one exemplary embodiment of the main web page 600 of the system according to the present invention. As shown in FIG. 6, the main screen 600 preferably includes these key components: widgets 605-612, tabs for widgets, activities and favorites 620-628, an experience control panel 630-640 and the Q button 650.

The main screen 600 is the application portal from which interactions with other users take place. The main screen may allow a user to browse through the digital images of other users within their current social network (LANscape). A user may select a member's image to gain additional information about that user. From the main page, the user may adjust the filters on each of the available widgets to discover which other users share their tastes and preferences among all the members signed onto the system. Additionally, the main screen may facilitate a breaking of the ice with other members through a humorous game, quiz or challenge.

Widgets 605-612 are interactive, user-configurable filters that convey dynamic information about users within a defined radius or LANscape. As shown in FIG. 6, any number and grouping of widgets 605-612 may be arranged within the main screen 600 by the user, each selected to show information about members within the user's social network or LANscape. For example, the largest window 610 within the main screen 600 of FIG. 6 shows the user's social LANscape, which is a graphical representation of the locations of and information about other members within the preset or user-defined radius. This radius may be set from the experience control panel at the bottom of the main screen 600, for example with radius selection push buttons 630. Other filtering aspects of the LANscape window 610 may also be controlled by the user including whether the display shows user gender or activities, and the type of view for the LANscape (pictures/map/explore) that is presented to the user.

Other widgets that have been selected and placed by this exemplary user are the “speed dating” and “hot seat” games 612 that may be frequently employed by the user. Also shown on this exemplary main screen 600 is a widget that continuously displays images of other members within the user's social LANscape 605. At the heart of the main screen 600 and the use of discrete widgets in general is the flexibility and user-definability of all aspects of the user experience. An almost limitless combination of games and other social activities may be customized by the user through the use of these widgets.

The experience control panel 630-640 allows a user to expand or contract the geographic area that comprises their social network or LANscape. Whenever the user changes their social LANscape setting, e.g., using the proximity control buttons 630, the entire main screen display 600 and all subsequent displays are changed accordingly to reflect the new social LANscape geography. The experience control panel 630-640 also allows a user to adjust settings related to the system's invitation process. For example, buttons 635 may be provided with which a user may toggle between having all invitations immediately displayed as they are received, having invitations held in a queue for later review and not immediately displayed, or filtering invitations according to user-defined parameters.

The experience control panel 630-640 also allows a user to decide whether to reveal their actual geographic location by selecting one of three relevant options (635). These options 635 include: (1) reveal the user's location to all users; (2) reveal the user's location to friends only; or (3) do not reveal the user's location. For security reasons, the “reveal location” control 635 automatically resets to “do not reveal location” each time a user logs in. A user may also determine on a global basis whether they wish to appear as “available” to other users, based on a selection made from the experience control panel (635). Options which a user may select include at least: available to all, available to friends, away or busy. When a user selects a status other than “available” the application intercepts all communications and informs other users as to the current status. Further, messages sent to the user may be accessed from another portion of the experience control panel (640).

Finally, the experience control panel allows users to limit their social LANscape to members of their main network affiliation (such as College Students, for example) or all members of the application regardless of network affiliation. This is represented by the “group” button 635 in the experience control panel.

The main screen 600 also contains five (or some other number) tabs 620-628 that allow a user access to widgets and activities. The widgets tab 625 is a dynamic tab that displays thumbnails of the widgets that are currently available for use on the application's main screen 600. To utilize a widget, the user simply drags a widget displayed in the widget tab 625 and drops it onto the main screen 600. The widget is then automatically launched. Rolling over the widget thumbnails allows the widget tab 625 to display a larger view of the widget and descriptive information. The widget tab 625 also preferably includes a reset button which allows the user to restore the default settings for the main screen widget display.

The main screen 600 of the present invention may include several activities tabs 620 which correspond to three activity categories: “Party” (containing social/party games); “Play” (containing competitive and college rivalry Games and access to game lobbies); and “Create” (containing access to user/group self-expression, publishing and common calendar functions). As with the widget tab 625, each activity tab 620 displays thumbnails of the category-specific activities that are currently available on the system. To access an activity from an activity tab 620, the user simply clicks on an activity button. The user is then presented with an activity queue screen or enters a game lobby, depending on the type of activity selected. These and other features and options related to the activity tabs 620 are set forth in more detail below.

In one or more preferred embodiments, the main screen also includes a favorites tab 628 that provides a user easy, one-click access to their favorite activities and widgets. To add an activity or widget to the favorites tab 628, the user can simply drag and drop an activity or widget from the main screen 600 or from another tab (e.g., 620 or 625). The user may also use a menu to pick an activity or widget from a list. In addition to user-selected favorites, the favorites tab 628 preferably includes two permanent items: access to editing the user's persona and access to joining, managing or displaying groups. These two common features are useful to all members.

The main screen 600 also contains a region referred to as the “Q-button” 650 which provides a quick navigation menu for the application. To access the navigation menu, a user clicks on the Q-button 650 which causes the Q to “open” and expose a menu. The menu offers access to a variety of functions, including at least: (1) search for people; (2) locations; (3) invite filters; (4) block/unblock; and (5) customize.

Within the Q-button menus, the “search for people” menu option offers a number of preset and advanced search capabilities using at least the following criteria: relationship status, past interactions, online vs. offline, group relationship, student status, interests and areas of knowledge. The “locations” menu options allow a user to browse for locations, get location information, read or create an entry for a location guestbook and switch to a remote location's LANscape (e.g., to visit another college campus). The “invitation filters” menu option allows a user to override the application's default setting of holding invitations, thus permitting the user to specify criteria that will govern which invitations the application will the user to receive and view.

Also in the Q-button menus, the “block and unblock” menu option provides the user with the ability to unblock users who have previously been blocked, or to change the status of blocked users from “block permanently” to “block for current session only” or vice versa. Finally, the “customize” menu item provides users with the ability to customize the backgrounds of all application screens and to select themes that change the menus and backgrounds in concert. Users are able to utilize pre-supplied backgrounds or to select a personal background of their choice. Although illustrative, the above-described Q-button menus and the widgets and tabs of the main screen are exemplary only, and do not limit the scope of the present invention to the particularly disclosed features and options.

Before customizing and using the main screen 600 shown in FIG. 6, a user must login and join the system. When a new member joins the system for the first time, the first thing they do is create an “application persona.” The application persona informs other users who they are and how they like to express themselves. The persona can be as brief as the user wishes and can be modified at any time.

Application personas perform two distinct functions. First, personas provide important background information to help members learn about each other and assess what they have in common. This background information may include college particulars, personal interests, likes and dislikes, and similar information. The system also uses this data to power its “lookouts” and “alerts” (see below), to automatically generate customized suggestions, introduce members, and kick off conversations (via the application's use of the SmallTalk engine; see below).

Another important function of the application's personas is to help members convey an instant first impression to others in a live and interactive environment. Users create an application persona's first impression using snippets of information that, at a glance, give creative insight into a user's personality, style, and sense of humor. These snippets of information are enticements that attract the attention of other application members and prompt them to want to know more. Application personas are not, however, a vehicle for in-depth self-expression. For that, the present invention provides “application personal pages.”

In embodiments of the present invention, regardless of from where a member logs in (e.g., a dorm room, a classroom or a coffee shop), the application may immediately place the user in a “social network.” The system's social network or LANscape acts as a bridge between the virtual realm of the Internet and the people, places and events that make up a member's real-world, real-time social surroundings.

Combining time-of-day information with geo-coding data that pinpoints a member's location (described above), the system automatically creates a social network that includes the “ideal” number of members desired at any one time. The social network may be as small as a few blocks, as wide as a college campus, or may extend for several miles around the user, depending on the number of people online within a member's proximity and/or the user's preferences. Members can adjust the size of their social network at any time too. Expand the radius and more people are included—up to 300 at a time. Focus in the radius, and their social network becomes more intimate. It's up to each member.

Whether access to the application is by a new member on their first login or by an existing member, the user is preferably first brought to a main system web page such as that shown in FIG. 6. On the main page 600, members enter their social network and access the system's many activities. The visual presentation of the main screen is preferably fully customizable. For example, it can appear like a large private party, a campus gathering place, or other lively meeting spots. Members can select the look and feel they prefer.

From the application's main screen 600, a user can browse (using buttons 608) through the digital images of everyone in their social network. A user may also select a member's image 605 to experience their individual personas. Users may change settings for the various filters and switches to discover which other users share their tastes and preferences among all the members signed on. Through these features, users may find friends and acquaintances on the application.

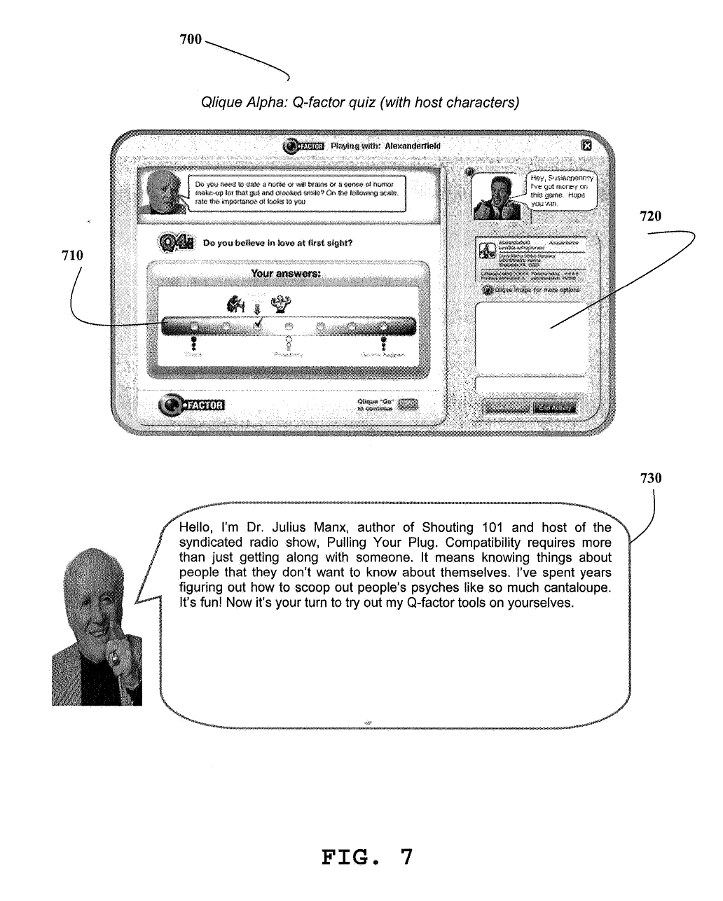

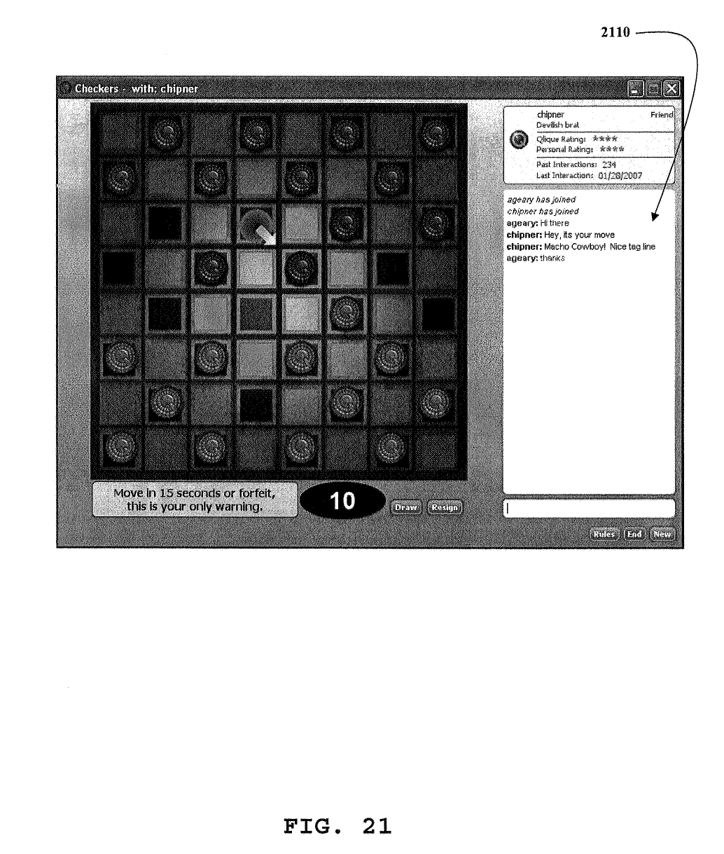

Users may also communicate with other users on the application by introduction using a chat window or by inviting another user to play a game or quiz. Exemplary games are shown in FIGS. 7, 14 and 21. Each of these contains a chat window (720 of FIG. 7 and 2110 of FIG. 21, for example) which allows for instantaneous communication between users of the application.

Users may also use public chat modes to express thoughts publicly which may then be displayed in a dialog bubble. They may enter a discussion lobby where members can let other members know what they are interested in talking about. If a topic of conversation was widely discussed or voted highly on by members, it could be designated a hot topic and be advertised in the discussion lobby. Once members agree on a similar topic, they can begin discussing it publicly or privately. A user may use the “SoapBox” widget which allows them to expound at length on whatever is on their mind and display that information to all users who are currently viewing that widget.

There are various social outlook widgets that are used to monitor the user's LANScape. As members log on and off of the system, the user's LANscape is constantly changing. These social outlook widgets will notify the user of important changes to their LANScape. Some of these widgets are: the “College Rivals” widget which searches in the user's LANscape for members who attend a rival college and the “One in a Million” widget which allows the user to set strict search parameters to find the perfect member in their LANscape. Once this member enters the user's LANscape, the widget will notify them. The “My Treat” widget signals other members in a user's current location that the user is willing to treat them to a real world item such as coffee or snacks in exchange for information. The “You've Got My Word” widget takes all of the persona information from members in the user's LANScape and strips random words from the personas to see which ones match the user's profile words. Those matching words are displayed randomly on the screen and can be clicked to find the user associated with them. Once a user has found an activity or a member of interest, the application is ready to help make a connection.

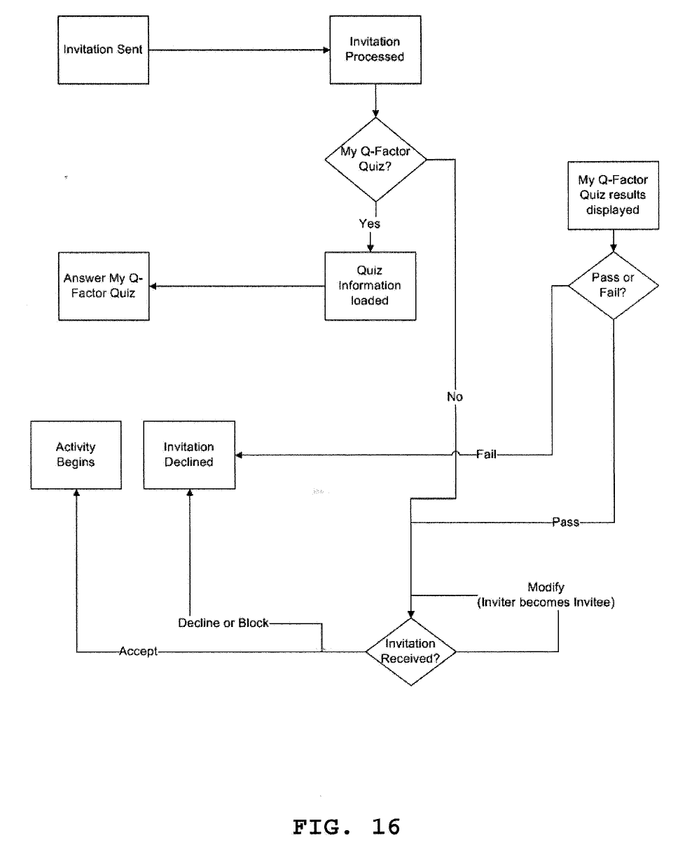

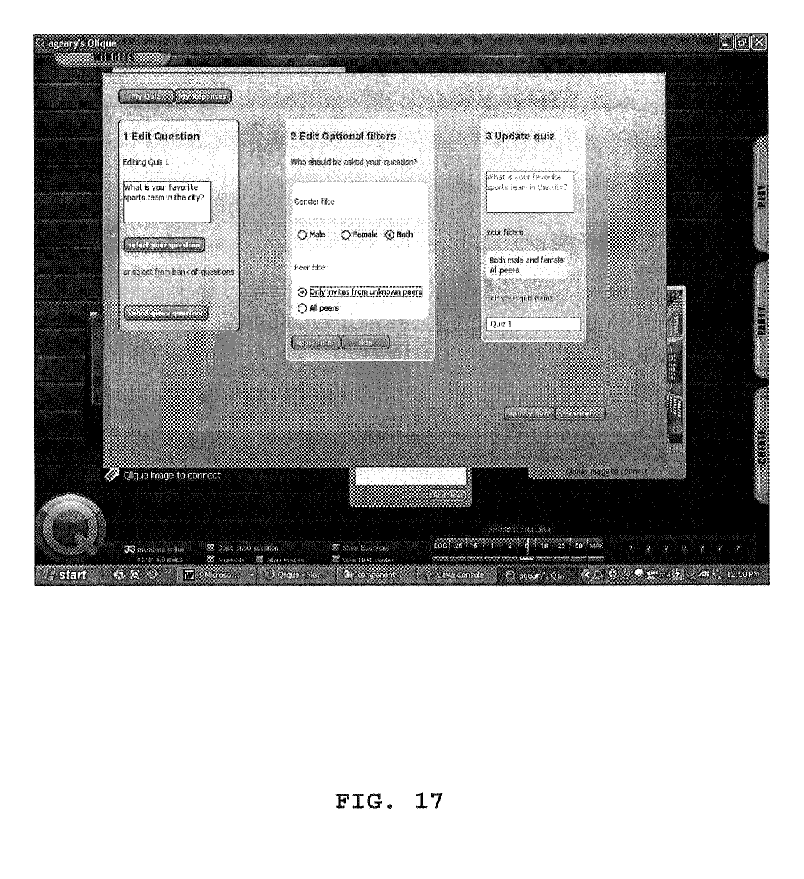

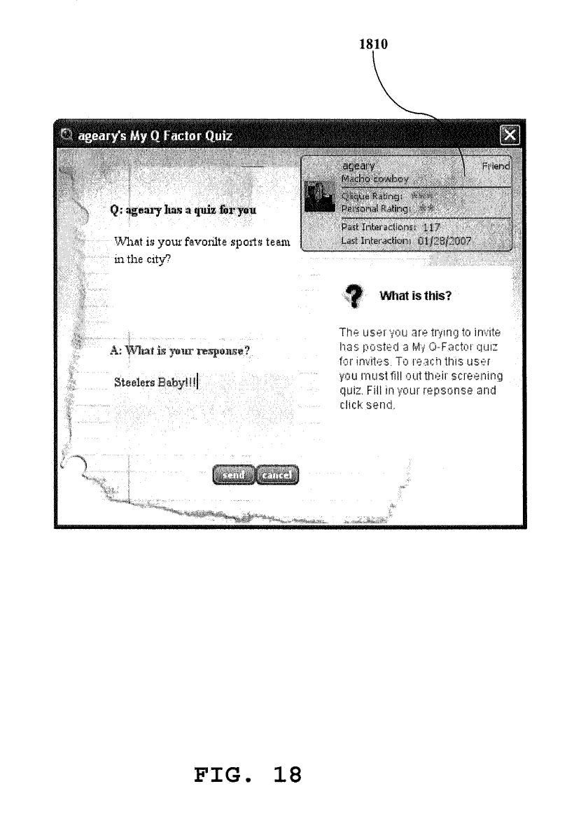

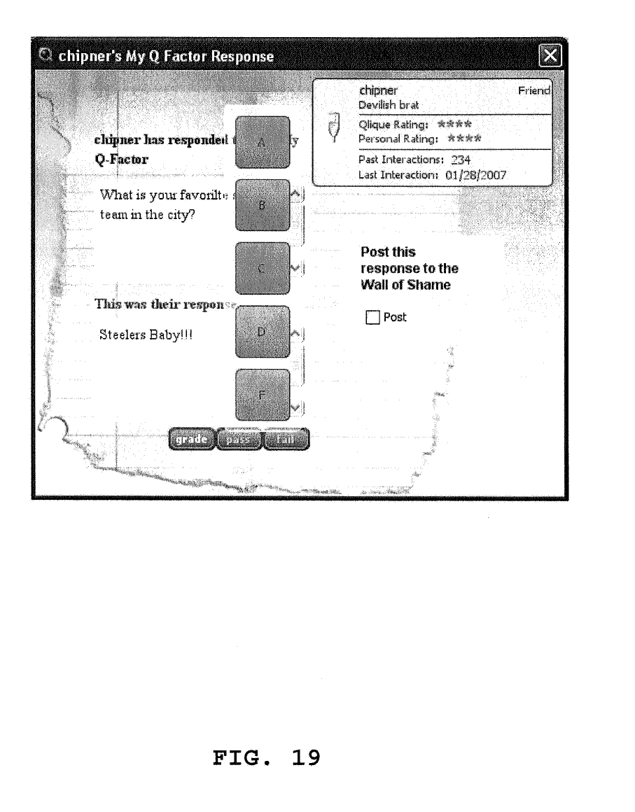

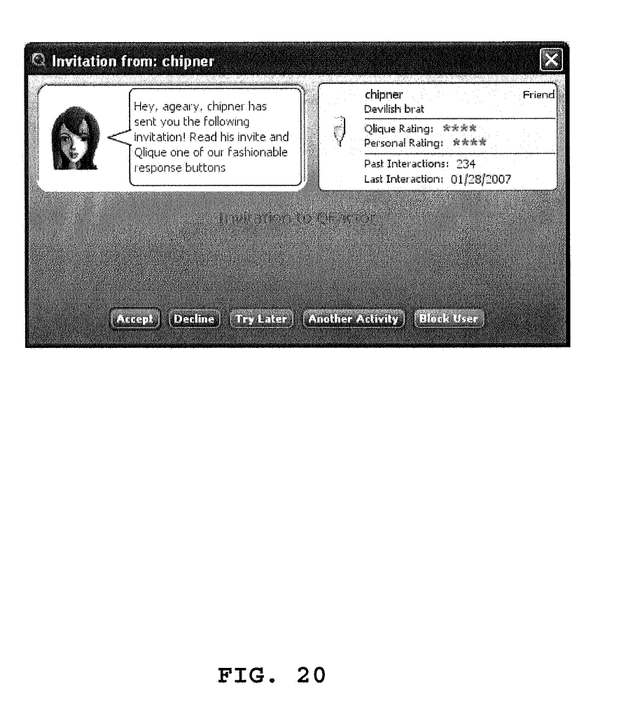

At the heart of system interaction is the “application invitation system.” This system allows user to request and report any potential social interactions with other members. FIG. 16 shows a workflow diagram of the application invitation system, and FIGS. 17-20 show an exemplary set of screen shots of the application invitation system in use. FIG. 17 is a screen shot of a user editing the questions they want to be presented to any user inviting them to a game or quiz. FIG. 18 depicts the question as presented to the user who is interested in playing a game with the first user. FIG. 19 is a screen shot of the answer the inviting user has provided to the first user's “My Q-Factor Quiz”, and FIG. 20 is the actual invitation which is sent back to the first user. This example is described in detail below.

The application invitation system makes it easy and comfortable for members to connect with each other and to invite others to participate in an application activity—even if they've never met. The application invitation system is there to assist both parties: the person doing the inviting and the member who is being invited. To assist the member initiating the invitation, the application automatically lists the other person's interests as well as the application activities they favor, highlighting anything the two parties have in common. The first member then selects an activity, adds a personal note and sends the invitation.

The application invitation system also helps members when they receive invitations. Application invitations display information about the person who has sent the invitation, including their application rating, and provide a range of automatic response choices: everything from acceptance to “please try later,” including the possibility of suggesting an alternative activity and a variety of polite refusals. As a result, even the application invitation process is a fun social interaction in which members learn about each other before participating in an actual application activity.

The optional “My Q-Factor Quiz” is a useful tool in screening potential social engagements. The application's My Q-Factor Quiz allows members to create personal mini-quizzes using humorous questions created by the application's writers or devising questions of their own. Once completed, a My Q-Factor Quiz may be taken by any member who wishes to test their wits, with their responses automatically submitted to the quiz maker for grading. My Q-Factor Quizzes permit both quiz makers and quiz takers to convey their individual personality and sense of humor. Also, a member may choose to have the application automatically administer their My Q-Factor Quiz whenever someone wishes to send an invitation. Should the quiz taker's responses pass muster, the quiz maker may then elect to proceed.

Application members can search through the My Q-Factor Quizzes of everyone in their social network to discover additional compatibility clues about their fellow application members or just to decide whose questions might be fun to answer.

The application uses a workflow-based invitation system (FIG. 16) for handling users' invitations to participate in application activities. Once an invitation is sent to a member, it enters into the invitation workflow engine. The invitation workflow engine allows the invitation to be passed back and forth between members as it enters different states. After an invitation is sent (opening element in FIG. 16), the application checks to see if a My Q-Factor Quiz is present. If so, the inviter must answer a question and send that response as part of their invitation. The invitee then reviews the answer and decides if they should accept the invitation. If no My Q-Factor Quiz is present, the invitee simply receives the invitation request directly.

Once the invitation is received, the invitee can accept, decline to suggest another activity. If the invitee suggests another activity, the invitation is sent back to the original inviter with the new information (FIG. 16). If the invitation is accepted, the activity begins. However, if the invitation is declined then the inviter is notified as such. The system processes these invitations by utilizing an invitation object that is passed back and forth between the application clients. The invitation manager tracks the progress of the invitation process and acts accordingly. The workflow aspect of the invitation system allows application developers to readily modify the invitation system at any time.

The downloaded client portion of the system also preferably includes a “SmallTalk engine” to start social interactions between members. The SmallTalk engine allows the application to provide simulated host characters which interact with users, respond to activity events and interject dialogue in the application environment. SmallTalk uses the persona information of participating users to allow the application's simulated host characters to make suggestions and initiate conversations based on user preference data. SmallTalk also provides personas for the application's simulated host characters similar to those of actual users. SmallTalk uses and responds to free-form text entered into a chat dialog and can display the dialog of an application's simulated host character in the same chat window or in a SmallTalk window.

SmallTalk is integrated in every activity in the application by way of the chat system. Each activity is based on of the activity application programming interface (API) which defines a base implementation of chat. This chat implementation intercepts all user messages passed back and forth and analyzes them for content. Various keywords and phrases are compared against the system database and randomly shown to users to stimulate interaction. Topics of discussion, questions and statements are suggested to script the users to interact with each other. The system also works off of user profile information scripting users to ask others about topics it knows they are interested in.

The system also allows members to view the LANscape of other locations as if they were logged in at those other locations. Members can search for locations using the Q-Menu (650) and visit these locations until they find one that they like. From there, a user can decide whether to physically visit these alternative locations. Prior to such a visit, members can review the information about people and activities within another LANScape.

The system also preferably includes a “Relationship” widget which allows users to organize their relationships with other members in the system. The system can also help members evolve relationships from online acquaintances to real-world introductions. The application provides two primary relationship categories—“Friends” and “Acquaintances.” Friend relationships require mutual consent and members may give special privileges to their Friends, such as access to restricted information or private personal page sections. Establishing an Acquaintance, on the other hand, does not require mutual consent, and special privileges that may be granted to Acquaintances are typically much more limited. The system makes it easy to keep track of both Friends and Acquaintances and offers alerts whenever they are online.

The Relationship widget also helps members develop relationships by keeping track of previous interactions between all application members, even those who are not Friends or Acquaintances (see 1810 in FIG. 18). For example, the application automatically records and displays: (1) the date of the most current interaction between members; (2) the total number of interactions between two members; and (3) members' ratings and comments about the quality of their interactions (1810). Members may use this information to search for people with whom they've had a great previous interaction or for members they've never met.

The main page 600 also keeps track of “alerts” for the member. The alerts keep a constant lookout for people, events, and activities of interest, sounding an alarm when such an opportunity presents itself. Application alerts are active even when members use another computer application and the application is operating in the background. The alerts are fully customizable and can be set by an application member to be triggered when, for example:
a Friend or Acquaintance comes online;
another member logs into the same physical location;
a person with knowledge of interest to the member enters the member's social network;
an application activity in which the member wishes to participate is ready to begin;
an invitation the member wishes to review has been received;
someone is viewing a member's personal page; and/or
a member with a high “commonality” score enters the social network.

The system's experience controls (630-640 in FIG. 6) allow members to customize their application experience to suit their personal needs. Experience controls enhance a member's comfort and security to ensure full enjoyment of the application's exploration and collaboration opportunities. As introduced above, exemplary experience controls may include:
Personal information control. Members can control who may access any information they designate as restricted.
Location confidentiality. The application, by default, will NOT communicate a member's exact physical location to another person unless they choose to have location information disclosed.
Reporting abuse. A member can at any time electronically report abusive or offensive behavior—behavior that can lead to membership revocation.
Blocking member contact. A member can permanently or temporarily block another member from any future contact.
Filtering invitations. Members can have the application automatically “hold” all invitations that do not meet specific member-selected criteria.
Validation of Group Status. The system allows user to be separated into groups. These groups can consist of General Members, College Student, Professions and many others. The system allows members to gain access to different groups in different way. For example, college students must provide a valid email address ending with a .edu. These groups' verification methods can be customized for each group type. Members can then choose to view members only from within their groups, or all members.

The main screen 600 also shows links to a member's “Q-sheet” and “calendar.” Q-sheet and calendar is an interactive, collaborative program guide listing events of interest to the member community. It displays real-world, offline events, filtered by their proximity to the member's actual location, as well as online activities taking place within a member's social network.

The Q-sheet and calendar will also allow members to indicate their likelihood to participate in any event or activity—from “thinking about it” to “I'm in”—and to discover the likelihood that others will attend. Q-sheet and calendar will also allow advertisers to reach Application members in a unique contextual environment.

### B. Competitive Games

The system's competitive games offer a different kind of socializing for members who prefer their interactions to include some collegial rivalry. The system's games include, but are not limited to, poker, backgammon, chess, checkers, blackjack, trivia and other competitive games.

The application stirs up competitive interest by promoting a huge array of potential rivalries, especially in the college setting: business students vs. theatre majors; freshmen vs. upperclassmen; fraternities vs. sororities; and/or students from one college vs. students from a rival school. For nearly every college group, the present invention identifies and encourages dozens of would-be rivalries. The system then taps this pool of potential competitors to promote competitive game matches.

The application showcases the results and standings of rival college groups on the application scoreboards displayed throughout the system universe. Every rivalry has its own scoreboard and every scoreboard posts both individual and group results, further fueling interest in friendly game competition.

### C. Additional Social Activities

The present invention's “chat” feature combines a traditional “instant messaging” (IM) service with an entertainment focus. Chat is available from any interactive screen on the application. For example, a user may chat with other members of the application from a game screen (1810 of FIG. 18), or by inviting them to chat from the application main screen 600. The entertainment focus of this feature of the application is generated as an “Opening Line” that the SmallTalk engine provides at the start of any chat session. That is, the opening line may be a humorous one-liner automatically generated by the system's SmallTalk engine. Likewise, the application may also prompt the system to suggest a conversation topic and conversation starter that the application knows will be of interest to a selected chat partner. The system will monitor chat between users and interject humorous/profound statements for the participants to discuss and debate. Chat is fundamental to the main screen 600 and online socializing. Because of this, chat is not only a stand-alone collaborative entertainment application but is also incorporated into every application activity (see FIGS. 7, 14 and 21).

The chat of the present invention includes a number of unique features that capture the essence of the system's interactive experience. Thus, the chat feature is more than just about conversing with members a user may already know. For students, chat can be a college-wide conversation or a way to strike up an acquaintance with a student at a nearby school. A chat session doesn't begin or end with a blank chat screen. Rather, the chat screen may displays a “Q-card” of key information about a member's chat partner and provides access to their persona. One such “Q-card” is shown in FIG. 18 (1810).

Use of chat's “Opening Line” feature will kick off a conversation with a humorous twist automatically generated by the SmallTalk engine. A user may also enable a “Q-Me” feature which allows the application to suggest conversation topics that the application knows are of interest to a user's chat partner. Further, chat may be enhanced by a “Pop the Question” button which allows the application to select an intriguing question at random from the application's SmallTalk question bank for the chat partners to discuss.

Each chat window also provides a “New Activity” button which allows chat partners to jointly select and move to a new activity. A user may also invite additional application members into a chat at any time. Finally, chat may be available through a number of other public IM services, so that users of various public Instant Messenger services may also interact on the application's site.

Beyond the social activity of chat, the application provides many interactive social games which are managed by a “Q-Factor game engine”. This game engine acts as a workflow engine, controlling the steps needed to progress through various “Q-factor” questions, statements, interactions and scoring. The questions, statements and flow are fully scriptable and the system may provide an unlimited number of questions and interaction types. By monitoring all user input and user details, the Q-Factor game engine may be able to interject and respond to users, using the captured information or information from user personas. This adds the element of application host character awareness and acts as if the characters are part of the conversation. The Q-Factor game engine allows non-technical staff, or users, to quickly and easily create or modify Q-Factor scripts.

The application also provides Q-factor Compatibility Quizzes running on the Q-Factor game engine which are humorous multi-player icebreakers in the guise of scientifically designed compatibility tests (FIG. 7). These quizzes combine several components on a single graphical user interface 700: a humorous question which may be answered (710) by the user, an automated Q-factor “compatibility experts” (720) who provide comments, and a chat window 730 which allows the participants to comment in real time with their quiz partner. Q-factor Compatibility Quizzes poke fun at the entire genre of online quizzes while making it easy and fun to get to know another user. Examples of such quizzes are: The Practice Break-up Compatibility Quiz; The Prattle of the Sexes Quiz; When Are You Going to Get a Real Job? Ambition Quiz; If You Were an Office Supply Product Compatibility Quiz; The Rooming Together Compatibility Quiz; Should We Even Be Talking Compatibility Quiz; and The Red State/Blue State Political Compatibility Quiz.

The application provides a host character 730 who compares and analyzes the players' answers, commenting on their similarities and differences. At the conclusion of each quiz, the host calculates a compatibility score and offers professional advice. The SmallTalk engine directs such a host character to interject these comments and advice in much the same that the system monitors chats between users to provide humorous statements for the participants to discuss and debate.

Embodiments of the system also provide a set of “party Games.” Party Games challenge users to loosen up, let down their inhibitions and reveal something surprising and original about themselves while others do the same. Party games range from two-person activities to games involving up to 20 members at a time. Some exemplary party games include the following.

Hot Seat. This is the system's version of Truth or Dare, where the topics are related to the central themes of a group's affiliation, such as student life, and the questions are available in three flavors: mild, spicy and red hot. The game allows members to choose a question level and display a question to another member. The higher the question level, the more points the members can earn.

Standard Deviation. This is a group game in which players may comment on various political, social and pop culture issues, and then wager how well they can gauge what average Americans feel about the same issues. This game allows players to determine who knows their fellow citizens best and how far each player deviates from the “norm.”

Speed Dating. This game allows users to question each other randomly. A user may know the gender of the other participants, but are not provided their identities. This game allows users to interact anonymously with each other in order to find members you would like to interact with further. This game may be played between members in the same location or the application may pull together members in a user's proximity.

Confessions. This game allows multiple players to reveal, turn by turn, the details of a life episode they'd rather forget, and then vote on the “best” of the revelations. The game begins safely enough—with total anonymity. During each subsequent round, however, a fact is revealed from each player's persona—unless they choose to pass. The winner is the player who has earned the most votes after everyone has passed.

Puzzle me. This is a two-person game in which each player races to complete a crossword puzzle that has been automatically assembled from words in each others' persona.

I Dare Ya. This is a location-based game in which the application's student members carry out a variety of creative tasks designed for specific game locations (college residence halls, quads, libraries, cafeterias, etc.). Players compete against and grade each other for completing their tasks with the appropriate flair.

Q-Bets. This is a location-based game of friendly wagers between members regarding the distinguishing characteristics or observable behavior of people who enter the members' location. Members bet on who will enter next and what characteristics they will have. Members guessing correctly will earn points.

Mystery Partner. In this game, the application may automatically assign a Mystery Partner to a user. If the user chooses to play the game, the user and the mystery partner race to see who can identify the other before time runs out. Each player is provided with clues that help them eliminate other Mystery Partner suspects until one player has enough info to make a positive ID.

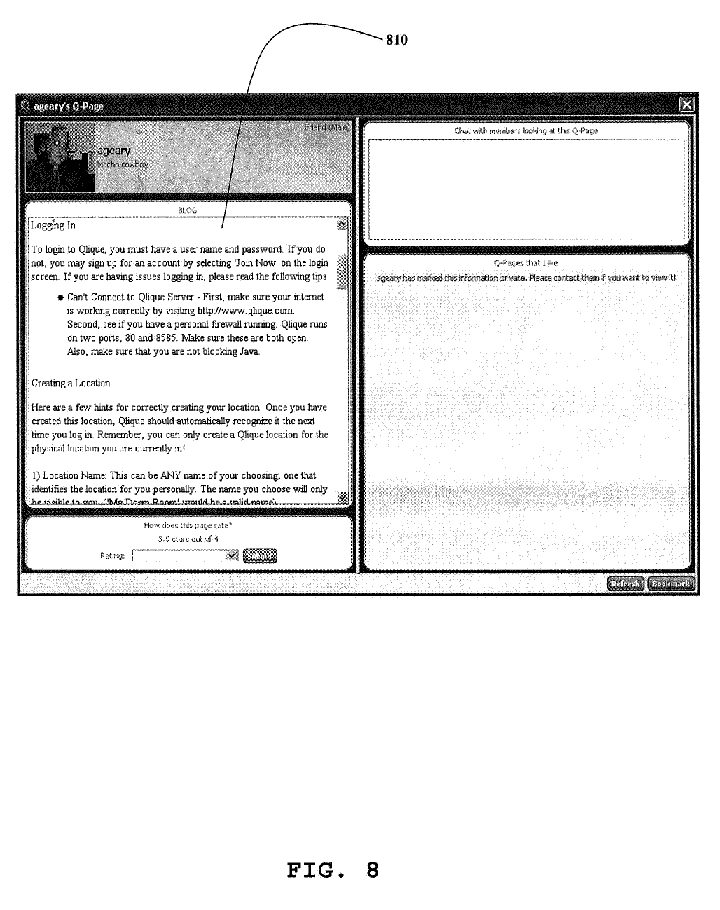

Another social activity provided by the system is the user's “personal pages” (FIG. 8). A personal page may provide users of the application with a forum for creative self-expression. Every member is encouraged to develop their own personal page (FIG. 8). On a personal page, members can display digital images, provide links for playing favorite music or video clips, post journal entries 810, showcase their talents, offer advice, and provide any personal information they'd like to share. Members may designate that selected personal page sections are open to anyone while restricting other sections to Friends or students from their own college, Further, the exact number and arrangement of items on a user's personal page (Q-page) are completely configurable by the user, as is the “skin” (background images and color scheme) for the page.

The system of the present invention also preferably includes functions in which users may publish information about themselves such as digital images or personal web pages. The system's “showcase” activity is a group activity that allows members to upload digital content for presentation to anyone who wants to join in as part audience member, part talent scout. To begin, members vote to select what content they want to see or hear from the choices presented by their fellow members. Members may base their selection preferences on previous ratings or on the reputation of the member offering the content. Once a selection is viewed or played, members rate the quality of the selection as well as the taste of the member who offered the selection. Members may invite others to this activity when they have content they wish to present.

To further encourage personal interaction, every personal page includes an option for adding a “living room”—a personal chat area where members can receive visitors, provide a tour of their page, and hang out with friends. Additionally, the system preferably alerts members when someone is visiting their personal page and informs page visitors when the creator of a page is online and available.

A personal page can also be readily transformed into a application group page, where groups of any kind can promote their group identity, disseminate information and maintain a central meeting place. Moreover, for members who maintain a personal page on another site and do not wish to create an entirely new page, the application can simply provide them links to other sites.

The system preferably also includes a “blogging” function 810. “Bylines” is the system's unique blogging application. It automatically combines the submissions of members into a dynamic, ever-changing online newspaper called Bylines. Bylines is specifically and especially designed to encourage “non-bloggers” to try their hand at this form of user-generated content. To prepare a Bylines submission, a member first creates an attention-grabbing headline. Then, they compose a “short take” of up to 200 words or a byline story of up to 1,000 words. Finally, they select a relevant Byline category for their submission, from humor to pop-culture to social commentary.

Bylines features multiple levels of distribution: from personal editions that include only a member's closest friends and favorite contributors, to local editions that focus on a member's current social network, to college, state and nationwide editions. Bylines submissions, in fact, automatically appear in numerous editions simultaneously, based on social groups and locations. The more popular the author and the particular submission becomes, the wider the distribution a submission will receive.

Like all activities, Bylines facilitate live, one-on-one connections between members. All Byline submissions include a “Member Online” indicator, showing whether the author is currently logged in. Bylines also provide access to a contributor's persona information and include a link to an archive of the author's previous work. Members can rate Byline contributions and send comments to the author.

### D. API

The Activity API allows developers to integrate various games and activities into the application. Once the application is aware of an activity, it will be advertised as an available activity and the application will allow users to invite each other to it. The activity workflow framework is a common API from which all activities are created. The framework defines much of the repeatable elements common to all activities. This allows developers to concentrate more on creating the intended user experience rather than spending time on integration. The framework defines a basic chat interface, all of the invite controls and all of the in-game controls such as “remove user,” “end activity,” and “new activity.”

### Exemplary System in Use

The above discussion provides a description of the system and its various components parts in varying levels of detail. However, some of the most advantageous attributes of the present invention are provided through the interactive nature of the system. Therefore, the following discussion provides a walkthrough of one or more exemplary user sessions in which various games and other application features are utilized. The discussion is guided by a variety of screen captures and flow charts of user decision-making processes.

A user may enter the application environment by first logging into the application from the webpage front end accessed through the World Wide Web of the Internet. As described above, the user may communicate with the application servers using either (1) a persistent socket opened directly to the application servers which allows communications to occur synchronously across this connection or (2) a direct HTTP connection which opens and closes, continuously polling the servers for queued data. The application servers may switch between these two modes while running, transparent to the user, for the best user experience.

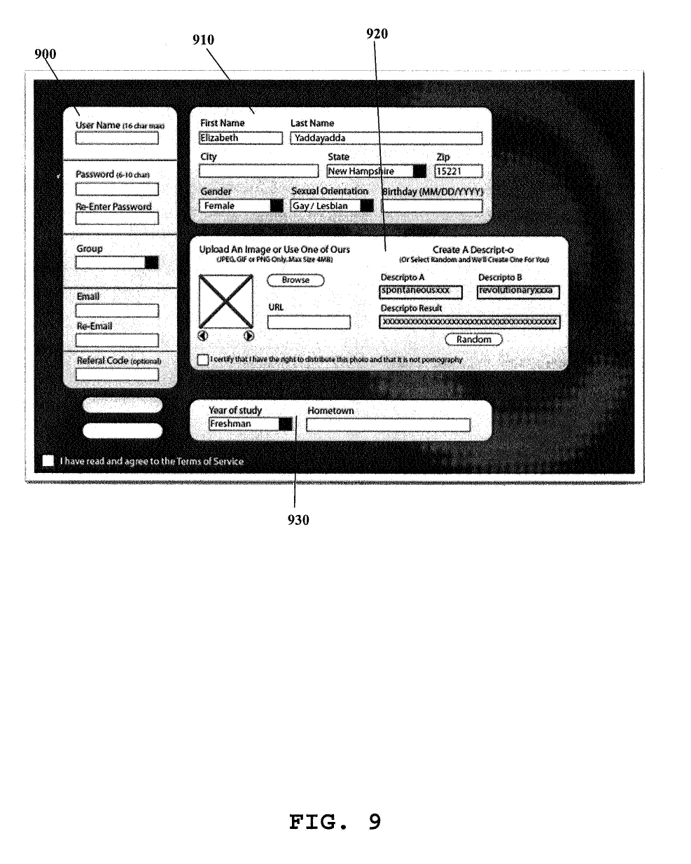

If the user has not yet created an account on the system, the user is queried for general account information with a screen such as that shown in FIG. 9. As seen in FIG. 9, this information may include, but is not limited to, system specific information (900) such as username, password, email address and/or a referral code. The system may also prompt the user for biographical information (910) such as first and last name, home address, gender, sexual orientation and birthday. In order to more closely match members, the system may also inquire about school or group affiliations, years of study in school (930), and a brief description term (920) which may be selected by the user or may be selected randomly by the application system. Additionally, the user is given an opportunity to upload an image(s) and a link to a webpage, which may typically be a personal webpage (920).

If the user is a college student, or wishes to be a member of the application affiliated with a specific group, the application may not allow a login until the group affiliation has been verified. For example, if the user is a college student, the system will send a unique link to the student at their college email address (e.g., to their email address which contains an .edu ending). The student user may then re-enter the application by clicking on this link in the email in order to confirm school affiliation.

If the user wishes to become a general member of the application system, or is not a college student (or other group member), the user may login to the system right after creating an account. A general member may view and communicate with other general members, but may not interact with college student members, or members of specific affiliation groups who do not wish to interact with general members. This restriction may be removed for members who are “friends”. That is, users may view members of their own group (college student or general, for example) and any member with whom they are linked as friends. This is described in more detail below.

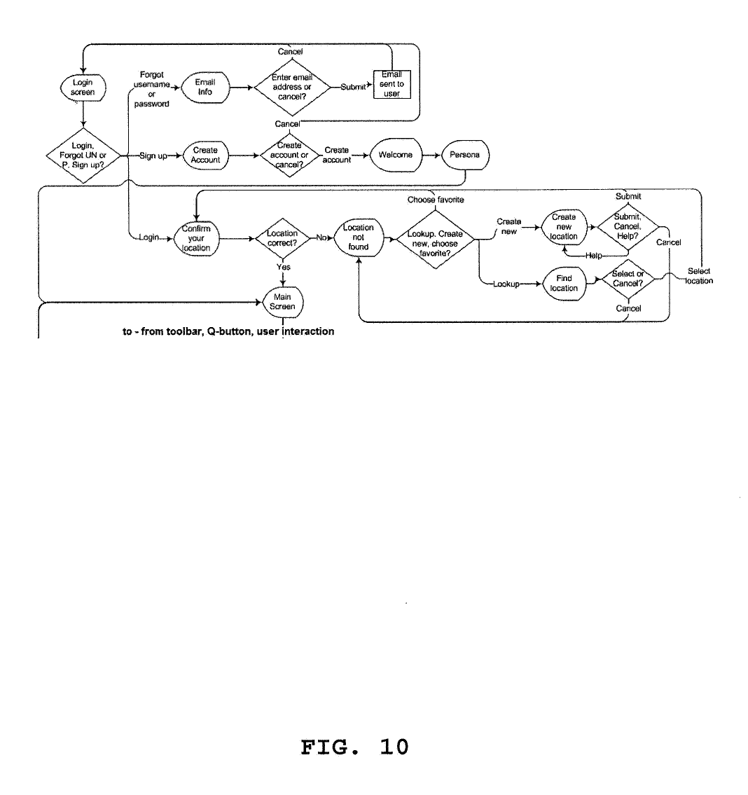

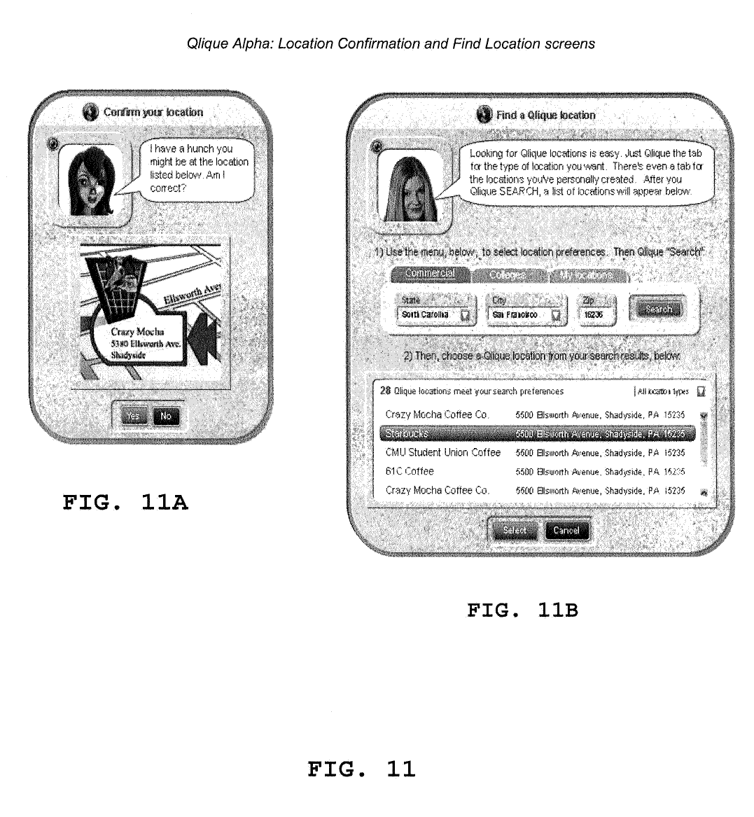

FIG. 10 shows a flow chart of the user login and location confirmation process from the system's perspective. At the login screen (1000), the user is queried for his/her username and password or can request to register with the system. If the user already has an account, but has forgotten their correct username, password or both, the user can request (1005) this information from the system. The information is then sent to the email address listed in the account information for the user (1010). FIG. 11 also shows the process described above with which a new user can register with the system (1015).

The user may login to the application by providing the correct username and password. Once a user connection is established, the application may then generate an accurate location for the user based on geo-coding (1020) according to one of the variety of methods described above with respect to FIG. 2. If the location is unknown or is incorrect, the application may ask the user to select a location from a list of possible locations (choose favorite), create a new location (create new) or the application may look up the location. A user interface screen such as that shown in FIG. 11B may be helpful in guiding the user toward his/her current location based upon predefined categories of locations. If the user is still unable to provide or select a correct location, they may be directed to an internet browser screen which may provide additional assistance (i.e., a user help screen).

Once a user location is determined by any of the above methods, the user is preferably presented with a location confirmation screen such as that shown in FIG. 11A. In FIG. 11A, the user is presented with a graphical view 1100 of there projected present location, and the system queries the user (via buttons 1105) to confirm his/her location. Once the user confirms his/her location, the user is directed to an application main screen such as that shown in FIG. 6.

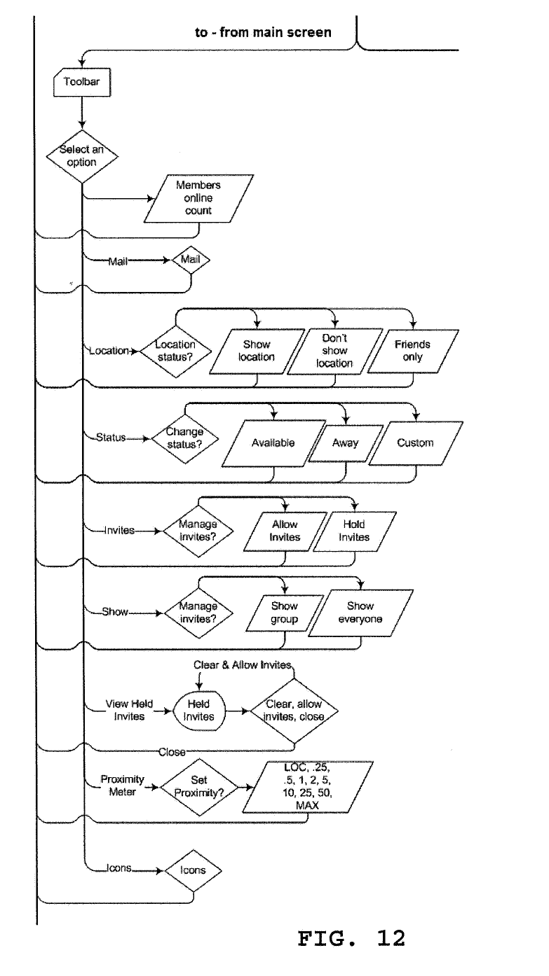

The main screen of the application has several tabs which allow the user to access a large variety of activities. For example, the user may access a toolbar that allows selection of application options which may be viewed and/or customized. FIG. 12 is a flow chart showing a mapping of exemplary user options as accessed from the main page. Examples of such options include (1) the members online count, (2) the user's mail, (3) the user's location status (e.g., who may view the user's current location), (4) the user's activity status (e.g., is the user available or unavailable?), (5) whether the user will allow invites from other users to participate in activities, (6) the radius set-point to be used in display and selection of the users LANscape and (7) what icons the user may wish to display on the main screen. Using the options set forth in FIG. 12, for example, the user may decide to hold invitations to participate in activities with other user members if they are busy using another feature of the application. The user may then view their held invites, and either accept the invitations, clear the invitations or close the toolbar. The user may also access the main screen toolbar to change the set-point radius that decides their LANscape, for example, so that more or less users are included (via slider bar 660 in FIG. 6).

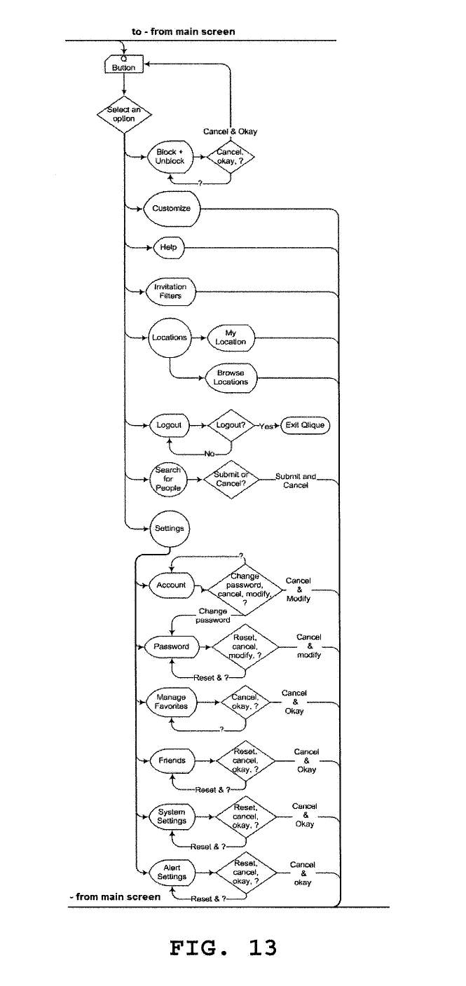

The user may also access tabs that allow for application status changes. For example, the FIG. 6 main screen 600 includes a Q-Button tab 650 which allows the user to select a variety of different status options as set forth in the flow diagram of FIG. 13. As seen in FIG. 13, further options allow the user to: (1) block or unblock a specific user; (2) customize the user's main screen colors and background images (e.g., the application skin); (3) find information on specific topics related to the application; (4) change the settings for the invitations filters; (5) change the user location; (6) search for specific users; and/or (7) exit the application by logging out. Additionally, the user may use the Q-button menu to view and change or set application settings. As also shown in FIG. 13, these settings include, but are not limited to: (1) account information such as the password; (2) lists of favorite user members; (3) lists of user members who are friends; (4) system settings; and (5) alert settings. Additional selectable settings are set forth in FIG. 13.

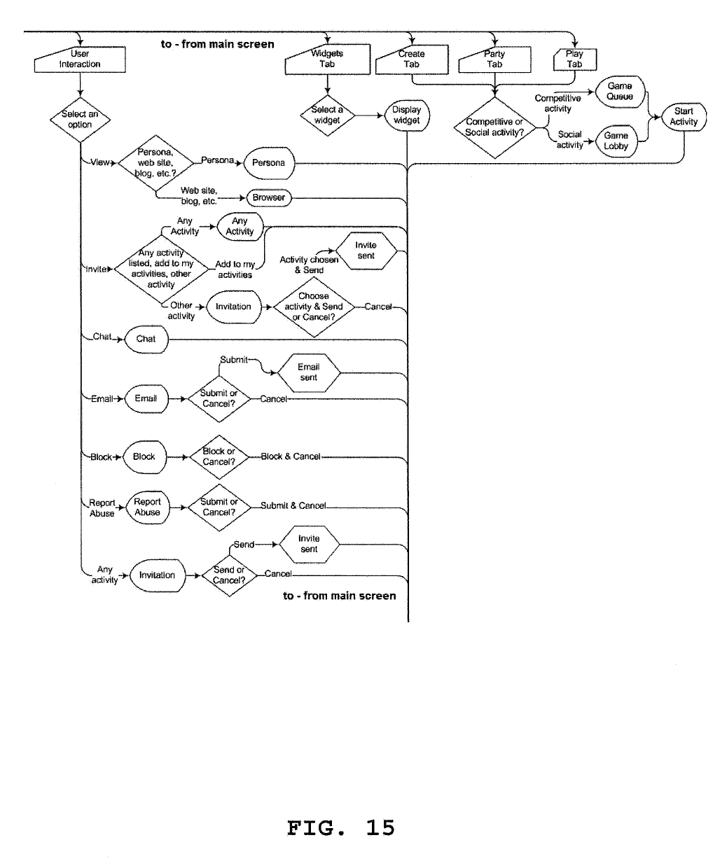

The user may also access tabs 620 from the application main screen 600 of FIG. 6 that provides additional functionality as set forth in the flow diagram of FIG. 15. As shown in FIG. 15, there may be a “create tab”, “party tab” and “play tab” (620) selections available. The user may then choose between a competitive or social activity, and the user will be put into either the game queue (for a competitive activity) or the game lobby (for a social activity). From these locations, one or more various activities may be started (FIG. 15).

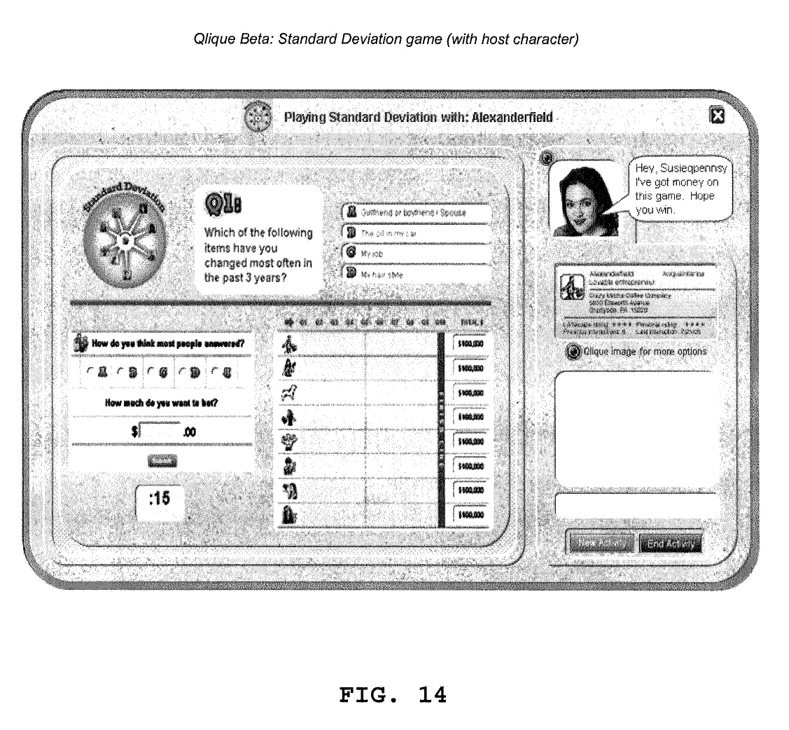

For example, the user may select the play tab to view the games which are available on the application. By using the play tab, the user will be directed to invite another user to participate in playing this game, which may be a regular game or a competitive game. Participation in these games may be with a single user member or with a group of user members. These games, also described above, include, but are not limited to competitive games such as poker, backgammon, chess, checkers, blackjack, College Trivia and other competitive games and party games. The application party games range from two-person activities to games involving up to 20 members at a time, and include games such as Hot Seat, Standard Deviation (see FIG. 14), Speed Dating, Confessions, Puzzle me, I Dare Ya (location-based game), Q-Bets (location-based game) and Mystery Partner, for example.

The Standard Deviation game shown in FIG. 14 is one example. Standard Deviation is a group game in which players discuss various political, social and pop culture issues, and then wager how well they can gauge what average Americans feel about the same issues. Members will first get a question and respond to it. Members will also bet on how other current members in the same session answered the same question. If a member guesses how others would answer the question, they gain points. After the question is answered, the system compares the current session's answers to that of other members across the application (in other sessions) to see how you the results compare.

Using the tabs on the main screen for game play may direct the user to a game queue or to an activity lobby. For example, the user may request to play a competitive chess game against the top ranked chess player member from a rival college. This request may be placed in a game lobby, and the top ranked chess player member from the rival college will be informed of the invitation.

Alternatively, the user may select to play a game with another user, and may be placed in the game queue. Here the user may wait for the invited user to respond to the invitation. The invited user receives the invitation which displays information about the person who has sent the invitation, including their rating, and provides a range of automatic response choices: everything from acceptance to “please try later,” including the possibility of suggesting an alternative activity and a variety of polite refusals. Thus, the invited user may decline the invitation or accept the invitation. Alternatively, the invited user may have requested that the application administer a Q-Factor Quiz to the invitee before they decide on any action.

A Q-Factor Quiz allows users to create personal mini-quizzes using humorous questions created by the application's writers or by devising questions of their own. A member may choose to have the application automatically administer their Q-Factor Quiz whenever someone wishes to send an invitation. Should the quiz taker's responses pass muster, the quiz maker may then elect to proceed. FIG. 17 depicts an exemplary screen from the application which allows a user to create a Q-factor quiz. In the example shown, any user unknown to this member who invites this member to an activity will be asked to answer the question “what is your favorite sports team in the city?”

A user who has invited this member to play a game will receive this question as a pop-up screen on their local device, as shown in FIG. 18, which allows the invitee to provide an answer via a freeform text box or other responsive device 1805. This pop-up screen may also display information 1810 on the invitee. Once the question has been answered and the user “sends” in the response 1815, the system will provide a pop-up screen on the invited user's local device which displays the invitee's response (see FIG. 19).

The invited member may then grade the response via enclosed buttons and decide whether to pass or fail the request, as shown in FIG. 19. If the invited user passes the request, an invitation screen (see FIG. 20) may then be provided to the invited user which allows the invited user to accept the request 2005, decline the request 2010 or suggest another activity 2015. Further, this invitation screen allows the invited user to block the invitee 2020, or suggest that the invitee try again later 2025.

If the invited user accepts the request, a game screen may appear on their local device which contains the game selected. For example, if the invitee requested that the two members play checkers, a screen such as the one shown in FIG. 21 may appear on the two members local devices. This screen may also contain a window which allows the two users to chat during game play (at right in FIG. 21).

The main screen shown in FIG. 6 also allows access to several user interaction tabs. As shown in the flow chart of FIG. 15, some of the interaction choices may include, but are not limited to: (1) persona and web pages; (2) invitations; (3) chat; (4) email; (5) block other users; (6) report abuse of the system; and (7) activity invitations. For example, the user may view, add and/or change information in their persona or on their personal blog pages. The user may chat with another user, or may send an invitation to another user to participate in a game.

The user may also select items from the widget tabs which may be displayed on the main screen (FIG. 6) and are also represented in the flow chart of FIG. 15. Information regarding the selected widgets and their arrangement on the main screen is saved to the user's local device. When the user logs out of the application and next re-enters, this saved information allows the main screen to be displayed with the same arrangement of widgets selected previously. This allows the user to customize their main screen according to their exact tastes.

The widgets act as portals or filters which display information pertaining to the user's current local device. These may include at least the user's LANscape, which is a radius map displaying members sorted by proximity and compatibility, screens which display images of members currently logged onto the application (“now appearing”), screens which display images of the user's friends (“a buddy list”), and screens which display announcements of games to be played in the future. An exemplary main screen setup is shown in FIG. 6.

The user may change the appearance of this main screen at any time, or may change the settings for the windows (widgets) viewed in the main screen. For example, the user may change the radius set points for their LANscape view. Or they may change the gender of members to be shown in their LANscape view. Additionally, a user may explore their LANscape to discover what other members are doing.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A method for providing a location-based social computing system, comprising the steps of:
receiving login information from a first user device;
polling said first user device to determine a geographic location of said first user device;
establishing a social network of additional user devices based on said geographic location of said first user device;
providing a graphical representation of said social network to said first user device.

2. The method of claim 1, wherein said login information from said first user device is received as part of a direct connection using a persistent socket.

3. The method of claim 1, wherein said login information from said first user device is received as part of a stateless HTTP (Hypertext Transfer Protocol) connection.

4. The method of claim 1, wherein said first user device is selected from the group consisting of a personal computer, a tablet computer, a cellular telephone, a personal digital assistant (PDA), a smart telephone, and a mobile laptop computer.

5. The method of claim 1, wherein the geographic location of the first user device is based on its hardware MAC (Media Access Control) address.

6. The method of claim 1, wherein the geographic location of the first user device is based on a user-selected location from a predefined list of stored locations.

7. The method of claim 1, wherein the graphical representation of said social network includes a pictorial representation of additional system users that are logged into the system from a location within a predefined geographic radius from the geographic location of the first device.

8. The method of claim 7, wherein said geographic radius is dynamically computed by the system based upon a predefined optimal number of additional users.

9. The method of claim 7, wherein said geographic radius is selected by a user of said first user device.

10. The method of claim 1, wherein said graphical representation of said social network further comprises:
at least one user-selectable widget for interacting with users of the system;
at least one graphical tab for accessing user-defined content; and
at least one experience control panel selector for altering user-defined functionality.

11. The method of claim 10, wherein said widgets include competitive games.

12. The method of claim 10, wherein said widgets include a social activity.

13. The method of claim 1, further comprising the steps of:
receiving information related to a compatibility quiz from said first device;
sending said compatibility quiz to a second device based upon an action of said second device;
receiving a response to said quiz from said second device and sending said response to said first device; and
receiving an evaluation of said response from said first device.

14. The method of claim 13, further comprising the step of:
sending an invitation to a social activity from said first device to said second device based upon the response to send compatibility quiz.

15. A location-based social computing system, comprising:
a database cluster;
at least one user device in communication with said database cluster for accessing said system;
means for determining the geographic location of said at least one user device;
means for determining a social network of users within a predefined distance from the geographic location of said at least one user; and
means for presenting a graphical user interface display on said at least one user device including a graphical representation of the location of each user of said determined social network.

16. The system of claim 15, further comprising:
a small talk engine for automatically instigating conversations between users of the system based upon information from user communications.

17. The system of claim 15, further comprising:
an invitation system adapted to facilitate invitations to various social interactions based upon a user-defined quiz.

18. The system of claim 15, further comprising:
an interactive chat feature.

19. A method for determining the geographic location of a client device in communication with a remote server, comprising the steps of:
receiving an electronic communication from said client device;
probing said client for a default gateway address to obtain location information;
comparing said obtained location information against a database of stored location information;
establishing the geographic location of said client device based on said comparing step.

20. The method of claim 20, wherein said probing step includes using an ARP command to obtain said obtained location information.
